(19) United States
(12) Patent Application Publication
(10) Pub. No.: US 2008/0083714 A1
(43) Pub. Date: Apr. 10, 2008

(54) Arc voltage estimation and use of arc voltage estimation in thermal processing systems

(75) Inventors: Girish R. Kamath, Lebanon, NH (US); John Miramonti, West Lebanon, NH (US); Norman LeBlanc, Claremont, NH (US); Christopher S. Passage, Canaan, NH (US); Wayne Chin, Lebanon, NH (US)

Correspondence Address: PROSKAUER ROSE LLP, ONE INTERNATIONAL PLACE, BOSTON, MA, 02110, US

(73) Assignee: Hypertherm, Inc., Hanover, MA (US)

(21) Appl. No.: 11/602,047

(22) Filed: Nov. 20, 2006

Related U.S. Application Data
(60) Provisional application No. 60/825,470, filed on Sep. 13, 2006.

(51) Int. Cl. B23K 9/00

(52) U.S. Cl. 219/121.57

(57) ABSTRACT

A system and method is featured for controlling a process parameter of a thermal processing system by estimating an arc voltage between a plasma arc torch tip and a metallic workpiece and controlling the process parameter based on the estimated arc voltage. Particular embodiments include adjusting the height of a plasma torch based on the estimated arc voltage. A system and method is also featured for estimating an arc voltage in a thermal processing system in which a switch mode power supply provides an arc current to generate a plasma arc between a plasma arc torch tip and a metallic workpiece.

### RELATED APPLICATIONS

This application claims the benefit of U.S. Provisional Application No. 60/825,470, filed on Sep. 13, 2006. The entire teachings of the above application are incorporated herein by reference.

This application relates to co-pending U.S. patent application Ser. No. ______, (Attorney Docket No. HYP-068) entitled “LINEAR, INDUCTANCE BASED CONTROL OF REGULATED ELECTRICAL PROPERTIES IN A SWITCH MODE POWER SUPPLY OF A THERMAL PROCESSING SYSTEM,” filed concurrently herewith. The entire teachings of the above application are incorporated herein by reference.

### BACKGROUND

Plasma arc systems are widely used for thermal processing of metallic materials, including cutting and welding. Such plasma arc systems can be configured to automatically cut or weld a metallic workpiece. In general, a plasma arc cutting system can include a plasma arc torch, an associated power supply, a remote high-frequency (RHF) console, a gas supply, a positioning apparatus, a cutting table, a torch height control, and an associated computerized numeric controller. FIG. 1 shows an example of a plasma arc system.

In operation, a user places a workpiece on the cutting table and mounts the plasma arc torch on the positioning apparatus to provide relative motion between the tip of the torch and the workpiece and to direct the plasma arc along a processing path. The user provides a start command to the computerized numeric controller (CNC) to initiate the cutting process. The CNC accurately directs motion of the torch and/or the cutting table to enable the workpiece to be cut to a desired pattern. The CNC is in communication with the positioning apparatus. The positioning apparatus uses signals from the CNC to direct the torch along a desired cutting path. Position information is returned from the positioning apparatus to the CNC to allow the CNC to operate interactively with the positioning apparatus to obtain an accurate cut path.

The power supply provides the electrical current necessary to generate the plasma arc. The power supply has one or more dc power modules to produce a constant current for the torch. Typically, the current can be set to discrete values. The power supply has a microprocessor, which regulates essentially all plasma system functions, including start sequence, CNC interface functions, gas and cut parameters, and shut off sequences. For example, the microprocessor can ramp-up or ramp-down the electrical current. The main on and off switch of the power supply can be controlled locally or remotely by the CNC. The power supply also houses a cooling system for cooling the torch.

The torch height control sets the height of the torch relative to the work piece. The torch height control, typically, has its own control module to control an arc voltage during cutting by adjusting the standoff, (i.e., the distance between the torch and the work piece), to maintain a predetermined arc voltage value. The torch height control has a lifter, which is controlled by the control module through a motor, to slide the torch in a vertical direction relative to the work piece to maintain the desired voltage during cutting.

The plasma arc torch generally includes a torch body, an electrode mounted within the body, passages for cooling fluid and cut and shield gases, a swirl ring to control the fluid flow patterns, a nozzle with a central exit orifice, and electrical connections. A shield can also be provided around the nozzle to protect the nozzle and to provide a shield gas flow to the area proximate the plasma arc. Gases applied to the torch can be non-reactive (e.g. argon or nitrogen) or reactive (e.g. oxygen or air).

In operation, the tip of the torch is positioned proximate the workpiece by the positioning apparatus. A pilot arc is first generated between the electrode (cathode) and the nozzle (anode) by using, for example, a high frequency, high voltage signal. The pilot arc ionizes gas from the gas console passing through the nozzle exit orifice. As the ionized gas reduces the electrical resistance between the electrode and the workpiece, the arc transfers from the nozzle to the workpiece. The torch is operated in this transferred plasma arc mode, which is characterized by the conductive flow of ionized gas from the electrode to the workpiece, to cut the workpiece.

### SUMMARY

Thermal processing systems, such as laser and plasma arc systems, are widely used in the cutting, welding, heat treating, and processing of metallic materials. There are a number of process parameters that are controlled in a thermal processing system. For example, with respect to plasma arc systems, the quality of the cut or weld in the metal workpiece depends upon maintaining a relatively constant distance between the tip of the torch and the metallic workpiece. This distance can be monitored indirectly by obtaining the arc voltage between the torch tip and the metallic workpiece. The greater the value of the arc voltage, the greater the distance between the torch tip and the workpiece. Conversely, the smaller the value of the arc voltage, the smaller the distance between the torch tip and the workpiece.

In prior systems, the arc voltage is obtained through a direct voltage measurement between the tip of the torch and the metallic workpiece. For example, FIG. 2 is a diagram that illustrates a torch height control system that measures arc voltage using a voltage divider board. As shown, a plasma arc controller 50 includes power block 58 under the control of an associated power control block 56. The power block 58 outputs a current I_{ARC} for generating a plasma arc between the tip of the plasma arc torch and a metallic workpiece. The output current I_{ARC} is fed through the input/output (I/O) board 54 to an electrode contained within the torch 10 via cable leads (not shown).

To measure the arc voltage between the tip of the plasma arc torch and the metallic workpiece, the plasma arc controller 50 includes a voltage divider board 52 internally coupled to the I/O board 54. The I/O board 54 is externally coupled to the tip of the torch 10 and the metallic workpiece 20 by cable leads (not shown). The voltage divider board 52 measures the voltage difference between voltages V_{T} and V_{W} to measure the arc voltage V_{ARC}. Typically, the voltage divider board 52 includes a resistor network and other complex circuitry that scales the actual arc voltage from a range of, for example, 0-350 Volts to 0-10 Volts.

The arc voltage measurement is then transmitted to the torch height controller 42 over any suitable communication link, including serial and analog communication links. In FIG. 2, the torch height controller is shown as an integral component of the computerized numeric controller interface (CNC) 40. In other embodiments, the torch height controller can be a separate component. Based on the arc voltage measurement, the torch height controller 42 determines the height of the torch relative to the workpiece, compares the present torch height with a preset height reference, and then directs command signals through the CNC 40 to the positioning apparatus 30. In response, the positioning apparatus 30 either lowers or raises the torch 10 in order to maintain a constant distance from the workpiece 20.

A disadvantage of direct measurement of arc voltage using a voltage divider board is cost and, in some cases, the introduction of transient noise which can affect the stability of the torch height control, for example.

According to one aspect, a system and method is featured for controlling a process parameter of a thermal processing system in which a switch mode power supply provides an arc current to generate a plasma arc between a plasma arc torch tip and a metallic workpiece. The system and method include structure or steps for estimating an arc voltage between the plasma arc torch tip and the metallic workpiece and controlling the process parameter based on the estimated arc voltage. For example, particular embodiments can include adjusting the height of a plasma torch based on an estimated arc voltage.

According to a first embodiment in which the switch mode power supply includes an output inductor, the arc voltage is estimated based on an average voltage applied to the input of the inductor. According to a second embodiment, the arc voltage is estimated based on the difference between an average voltage applied to the input of the inductor and a voltage drop across the inductor. According to a third embodiment, the arc voltage is estimated by obtaining a time varying profile of expected variations in arc voltage and estimating the arc voltage from a model representing changes in arc current through the inductor. The model can be based on an average voltage applied to an input of the inductor and the time varying profile of expected variations in the arc voltage.

According to another aspect, a system and method is featured for estimating an arc voltage in a thermal processing system in which a switch mode power supply provides an arc current to generate a plasma arc between a plasma arc torch tip and a metallic workpiece.

According to a first embodiment, the arc voltage is estimated by obtaining a duty cycle of the switch mode power supply; obtaining a value representing a dc input voltage of the switch mode power supply; and estimating the arc voltage between the plasma arc torch tip and the metallic workpiece based on a combination of the duty cycle of the switch mode power supply and the value representing the dc input voltage of the switch mode power supply. The combination can be one of a summation or product. The duty cycle of the switch mode power supply can be calculated based on a ratio of a sampled error signal to a peak value of a carrier wave signal, the sampled error signal comparing a measured value of the arc current to a preset current reference. The value representing the dc input voltage of the switch mode power supply can be measured or derived from an ac input voltage, for example. The value representing an input voltage of the switch mode power supply, including both ac and dc values, can be scaled.

According to a second embodiment in which the switch mode power supply includes an output inductor, the arc voltage is estimated by obtaining an average voltage applied to an input of the inductor; obtaining a value corresponding to a voltage drop across the inductor and estimating the arc voltage based on the difference between the average voltage applied and the voltage drop. The average voltage applied to the input of the inductor can be based on the product of the duty cycle of the switch mode power supply and a value representing the dc input voltage of the switch mode power supply. The voltage drop across the inductor can be obtained based on time varying change in current through the inductor.

According to a third embodiment in which the switch mode power supply includes an output inductor, the arc voltage is estimated by obtaining a time varying profile of expected variations in arc voltage; obtaining an average voltage applied to an input of the inductor; and estimating the arc voltage from a model representing changes in arc current through the inductor. The model can be based on an average voltage applied to the input of the inductor and the time varying profile of expected variations in the arc voltage. The time varying profile can be a mathematical or statistical representation of expected variations in arc voltage.

According to another aspect, a particular system for controlling a process parameter of a thermal processing system is featured. The system comprises a switch mode power supply that provides an arc current to generate a plasma arc between a plasma arc torch tip and a metallic workpiece; an arc voltage estimation module that estimates an arc voltage between the plasma arc torch tip and the metallic workpiece; and a process controller that controls a process parameter of the thermal processing system based on the estimated arc voltage. The process controller can be a torch height controller that adjusts the height of a plasma arc torch based on the estimated arc voltage.

According to a first embodiment, the arc voltage estimation module estimates the arc voltage based on an average voltage applied to the input of the inductor. According to a second embodiment, the arc voltage estimation module estimates the arc voltage based on the difference between an average voltage applied to the input of the inductor and a voltage drop across the inductor. According to a third embodiment, the arc voltage estimation module estimates the arc voltage from a model representing changes in current through the inductor, the model being based on an average voltage applied to an input of the inductor and a time varying profile of expected variations in the arc voltage.

In any of the embodiments, the switch mode power supply can be based on a boost, buck, or buck-boost circuit topology, including variations thereof.

### BRIEF DESCRIPTION OF DRAWINGS

FIG. 1 shows an example of a plasma arc system.

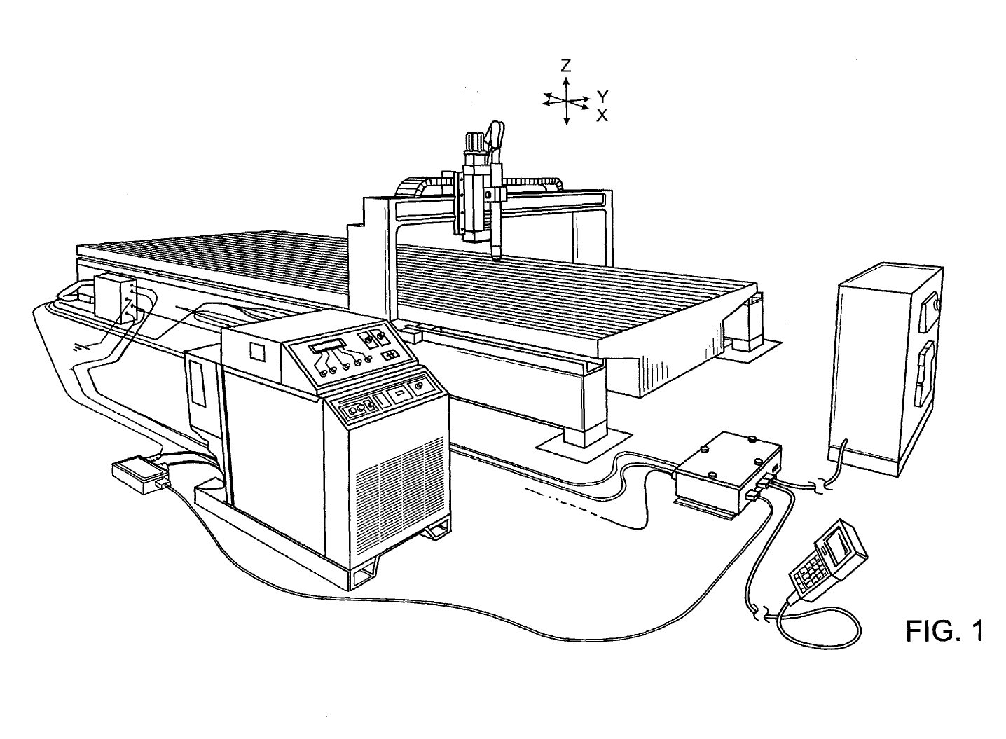

FIG. 2 is a diagram that illustrates a torch height control system that measures arc voltage using a voltage divider board.

FIG. 3 is a diagram that illustrates a torch height control system that obtains the arc voltage through an arc voltage estimation technique.

FIG. 4 is a circuit diagram of the power control block that includes an arc voltage estimation module.

FIGS. 5A and 5B are signal diagrams that represent a gate signal over one cycle for exemplary error and carrier signals.

FIG. 6 is a flow diagram illustrating a method of arc voltage estimation according to the first embodiment.

FIG. 7 is a flow diagram illustrating a method of arc voltage estimation according to the second embodiment.

FIG. 8 is a flow diagram illustrating a method of arc voltage estimation according to the third embodiment.

### DETAILED DESCRIPTION

According to one aspect, a system and method is featured for controlling a process parameter of a thermal processing system by estimating an arc voltage between the tip of the plasma arc torch and a metallic workpiece and controlling the process parameter based on the estimated arc voltage. For example, particular embodiments can include adjusting the height of a plasma torch based on an estimated arc voltage.

According to another aspect, a system and method is featured for estimating an arc voltage in a thermal processing system that includes a switch mode power supply for providing an arc current to generate a plasma arc between the tip of the plasma arc torch and a metallic workpiece.

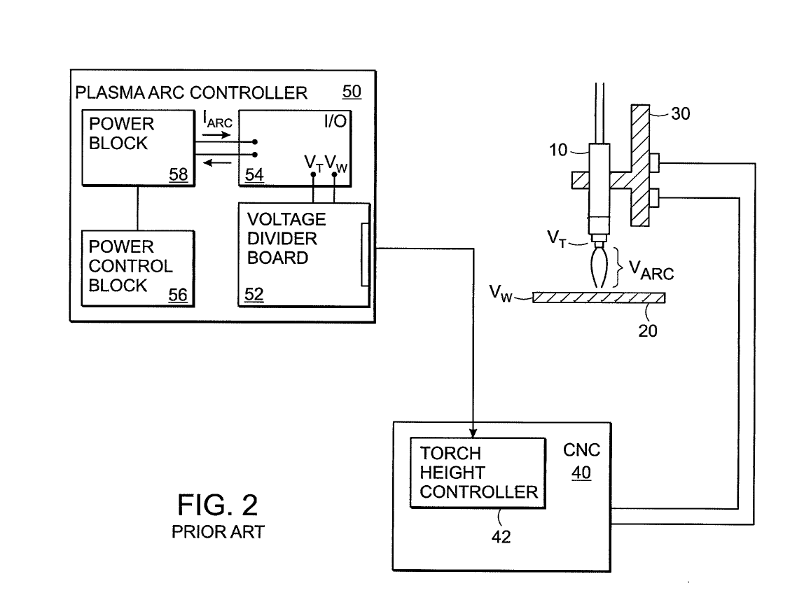

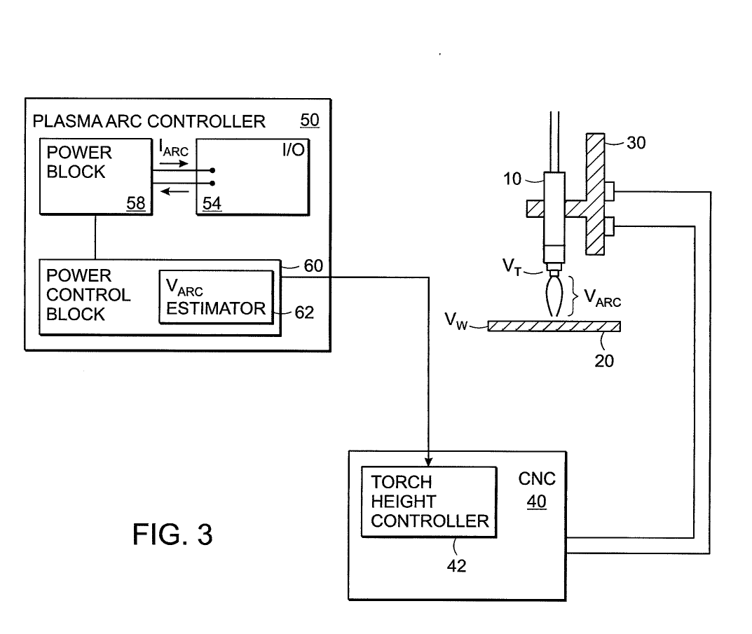

FIG. 3 is a diagram that illustrates a torch height control system that obtains the arc voltage through an arc voltage estimation technique. Although torch height control is one application of arc voltage estimation, other embodiments can use arc voltage estimates to control other process parameters in a thermal processing system. A difference between FIG. 3 and FIG. 2 is that the plasma arc controller 50 includes a modified power control block 60 that incorporates an arc voltage estimation module 62. The arc voltage estimation module 62 utilizes information obtained from the power block 58 and the power control block 60 to estimate the arc voltage.

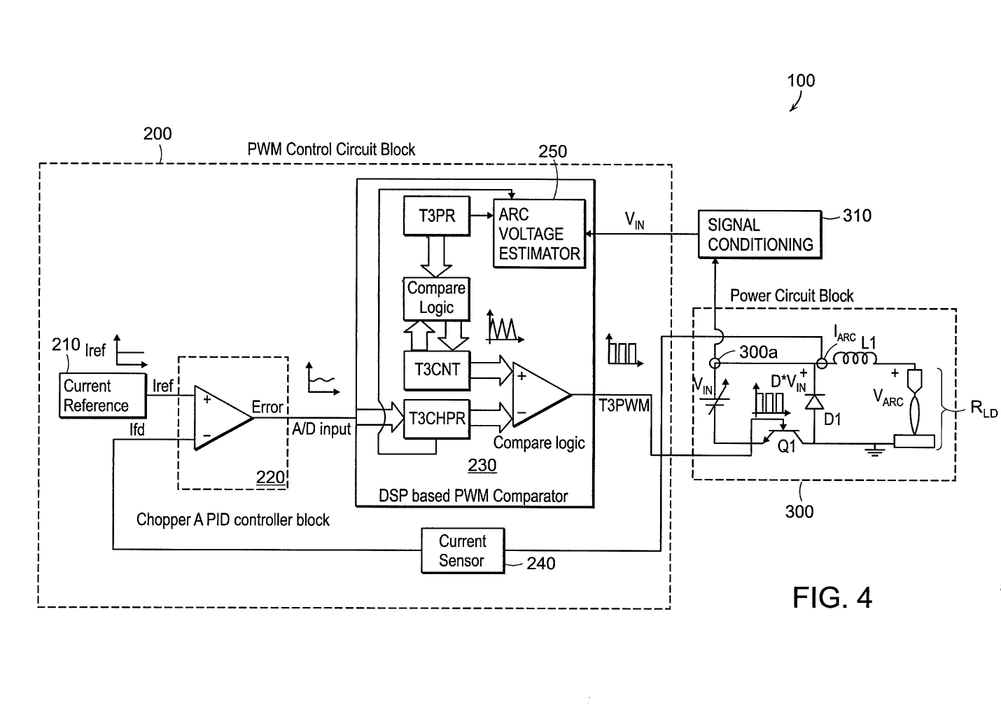

FIG. 4 is a circuit diagram of the power control block that includes an arc voltage estimation module. As shown, the circuit 100 includes a Pulse Width Modulation (PWM) control circuit block 200 coupled to a power circuit block 300. The power circuit block 300 is a switched mode power supply that includes an unregulated dc input voltage source V_{IN}, a power transistor switch-diode combination Q1, D1, an output filter inductor L1 and a plasma arc load R_{LD}. The power circuit block 300 operates as a standard chopper such that the output current I_{ARC} through the arc load R_{LD} depends on the duty cycle of the switch Q1. Although the power circuit block 300 shown is a buck converter, other embodiments can include other circuit topologies, including boost, buck-boost and variations thereof. For example, an inverter is a form of a buck converter.

The PWM control circuit block 200 provides a gate signal T3PWM to the switch Q1 to control its duty cycle, and thus the output current I_{ARC} through the plasma arc load R_{LD}. As shown, the PWM control block 200 includes a current reference block 210, an error control block 220, a feedback current sensor 240, a PWM comparator block 230, and an arc voltage estimation module 250.

An operator of the system manually sets block 210 to a desired current reference I_{REF} at which to maintain the output current I_{ARC}. The output current I_{ARC} is monitored using the current sensor 240, such as a Hall current sensor. The current sensor 240 transmits a feedback current I_{FB} to an input of the error control block 220. The error control block 220 can be implemented, for example, as a standard proportional-integral-derivative controller (PID controller) known to those skilled in the art. The error control block 220 compares the feedback current I_{FB} against the desired current reference I_{REF} and outputs a modulating error signal, Error.

The error signal, Error, is then input to the PWM comparator block 230 where it is sampled and used to generate the appropriate gate signal T3PWM that adjusts the duty cycle of the switch mode power supply 300, thereby correcting for the error in the output current. The PWM comparator block 230 and the arc voltage estimation module 250 can be realized using a digital signal processor (DSP), such as TMS320LF2407A from Texas Instruments. These control blocks can also be realized using a combination of one or more suitably programmed or dedicated processors (e.g., a microprocessor or microcontroller), hardwired logic, Application Specific Integrated Circuit (ASIC), or a Programmable Logic Device (PLD) (e.g, Field Programmable Gate Array (FPGA)) and the like.

In order to generate the appropriate gate signal T3PWM, the PWM comparator block 230 compares an instantaneous error sample T3CMPR with a carrier wave signal T3CNT. The carrier wave signal can be generated as a sawtooth or triangular carrier wave with its frequency ranging anywhere from hundreds of Hertz to MegaHertz depending on the application. In a plasma cutting application, the frequency of the carrier wave signal is typically around 15 kHz. The comparator amplifies the difference between the two signals and produces a gate signal T3PWM whose average value over one switching cycle of the carrier wave signal T3CNT is equal to the value of the instantaneous error sample T3CMPR. Application of the gate signal to the switch Q1 adjusts the duty cycle to drive and maintain the output current I_{ARC} at a desired steady state value.

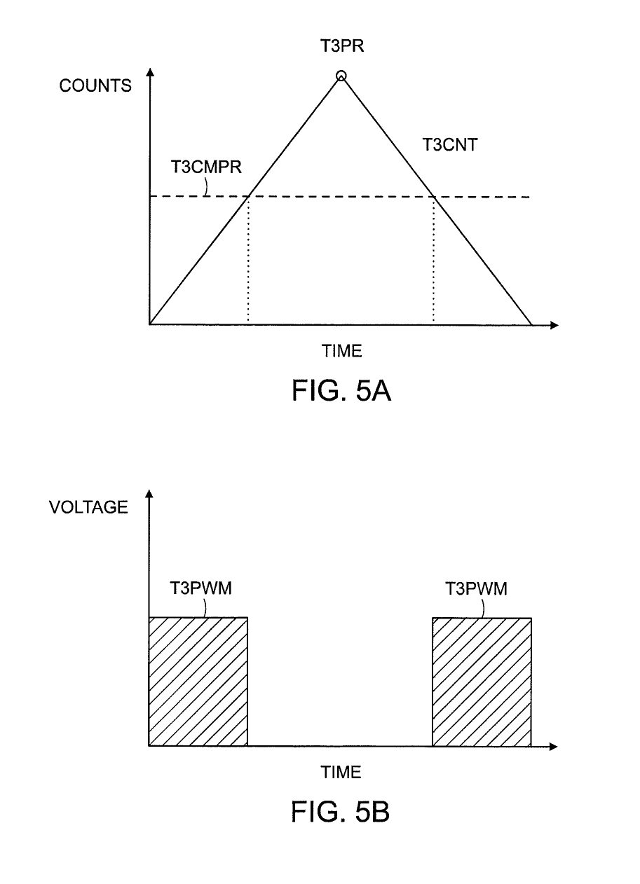

FIGS. 5A and 5B are signal diagrams that represent a gate signal T3PWM over one cycle for exemplary error and carrier signals, T3CMPR and T3CNT. The peak of the timing signal T3CNT is identified as T3PR. In this example, the output current I_{ARC} is less than the current reference I_{REF}, resulting in an instantaneous error sample T3CMPR as shown in FIG. 5A. In order to correct for this error, the PWM comparator block 230 compares the error sample T3CMPR against the carrier wave signal T3CNT. For one switching cycle, the comparator block 230 generates pulses T3PWM, while the value of the error sample T3CMPR is more than the incrementing value of the carrier wave signal T3CNT. These pulses, as shown in FIG. 5B, are used to enable and disable the switch Q1 of the switch mode power supply 300. By turning the switch Q1 ON and OFF in this manner, the duty cycle of the switch mode power supply can be adjusted to correct and maintain the output current at the desired current reference.

According to a first embodiment, the method for arc voltage estimation is based on the principle that inductor voltage drop is zero at constant arc current I_{ARC}. This implies that the average dc voltage at the input of the inductor L1 is equal to the average value of the arc voltage V_{ARC}. Thus, an estimate of the average arc voltage V_{ARC} can be determined by calculating the product of the steady state duty cycle D_{SS} of the switch Q1 and a dc input voltage V_{IN} according to equation (1):

V_{ARC}=D_{SS}*V_{IN} (1)

### As known to those skilled in the art, it is also possible to implement the product as a summation.

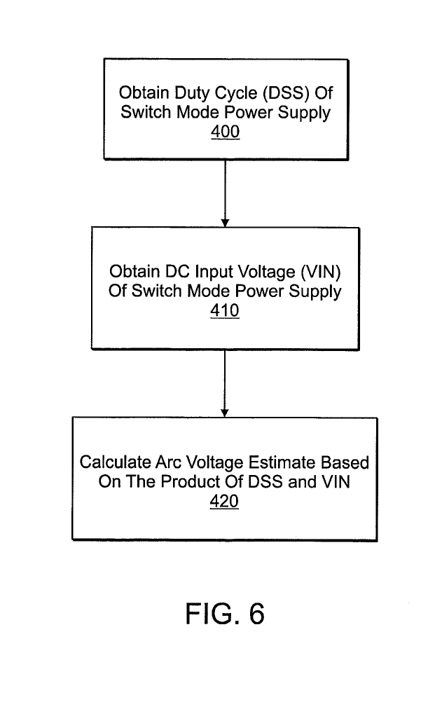

FIG. 6 is a flow diagram illustrating a method of arc voltage estimation according to the first embodiment. At step 400, the arc voltage estimation module 250 obtains the steady state duty cycle D_{SS} of the switch mode power supply. The steady state duty cycle D_{SS} can be calculated as the ratio of an instantaneous error sample T3CMPR to the peak of the carrier wave signal T3PR. For example, if the peak of the carrier wave signal equals 1070 counts and the instantaneous error sample T3CMPR corresponds to 535 counts, the steady state duty cycle D_{SS} is 50%.

At step 410, the arc voltage estimation module 250 obtains the dc input voltage V_{IN}. As shown in FIG. 4, the arc voltage estimation module 250 can obtain the dc input voltage V_{IN} through a tap 300a. Because the unregulated dc input voltage V_{IN} can have a magnitude in the range of hundreds of Volts, signal conditioning circuitry 310 can be used to scale down the voltage V_{IN} to a voltage suitable for processing by the arc voltage estimation module 250.

The dc input voltage V_{IN} can also be determined from the input ac voltage V_{ACIN} (not shown). The input ac voltage V_{ACIN} is an ac voltage from which the dc input voltage V_{IN} can be derived, for example, through a rectifier stage. The arc voltage estimation module 250 can determine the dc input voltage V_{IN} from the peak value of the input ac voltage V_{ACIN}. The dc input voltage V_{IN} can also be derived from the root mean square (RMS) value of the input ac voltage V_{ACIN}. Other methods for translating an input ac voltage to a dc input voltage can also be implemented. Because the input ac voltage V_{ACIN} can have a magnitude in the range of hundreds of Volts, signal conditioning circuitry 310 is used to scale down the input ac voltage V_{ACIN} to a voltage suitable for processing by the arc voltage estimation module 250.

At step 420 of FIG. 6, the arc voltage estimation module 250 calculates the arc voltage estimate V_{ARC} as the product of the duty cycle D_{SS} of the switch mode power supply and the dc input voltage V_{IN}. Although this estimate of arc voltage V_{ARC} may or may not provide the same accuracy as would direct measurement of the arc voltage, it is suitable for the purpose of particular applications, including torch height control, in that it filters out the transient noise that could produce jitter or other instability. In other applications, such as in arc current control applications, more accuracy in the estimation of arc voltage may be required. An example of current control that uses an arc voltage estimation is disclosed in co-pending U.S. patent application Ser. No. ______, (Attorney Docket No. HYP-068) entitled “LINEAR, INDUCTANCE BASED CONTROL OF REGULATED ELECTRICAL PROPERTIES IN A SWITCH MODE POWER SUPPLY OF A THERMAL PROCESSING SYSTEM,” filed concurrently herewith. The entire teachings of the above application are incorporated herein by reference.

According to a second embodiment, the method for arc voltage estimation additionally accounts for the voltage drop in the inductor according to the Equation (2) below.

$${V}_{Arc} = D * {V}_{IN} - L \frac{d i}{d t} \qquad ( 2 )$$

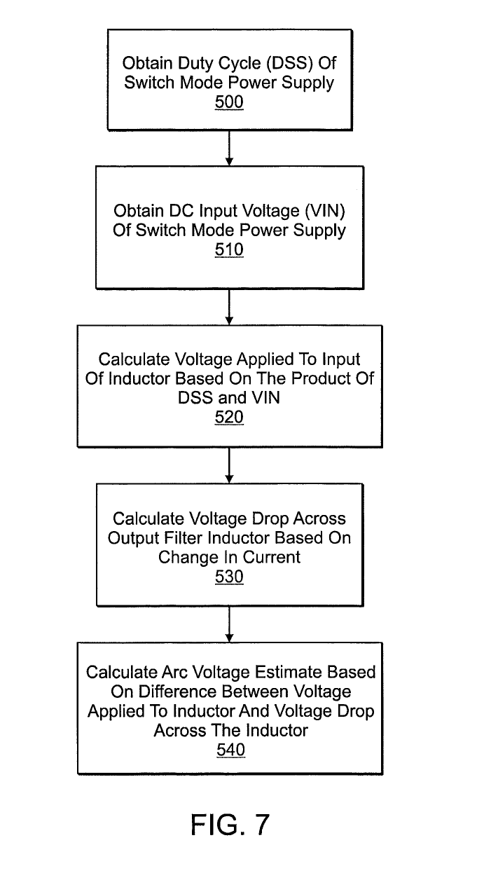

FIG. 7 is a flow diagram illustrating a method of arc voltage estimation according to the second embodiment. Steps 500, 510 and 520 are similar to steps 400, 410 and 420, respectively, as previously described in FIG. 6. At step 530, the arc voltage estimation module 250 calculates the voltage drop across the inductor L1 from the product of its inductance and the change in output current I_{ARC} Equation (2), which is a continuous linear equation, can be discretized using currents and voltages sampled on a regular basis. For example, Equation (2) can be transformed into a discrete representation for arc voltage by making the following substitution:

$$L \frac{d i}{d t} = L * ( {I}_{s} - {I}_{s} * {z}^{- 1} ) = L * ( {I}_{s} * ( I - {z}^{- 1} ) ) \qquad ( 3 )$$

where current sample Iₛ is a present sample of the inductor current, current sample Iₛ*z⁻¹ is a preceding sample of the inductor current, and L is the inductance of the inductor L1. In this example, Equation (2) is discretized using a backwards Euler transform. However, other discretization transforms known to those skilled in the art can also be used. For example, another discretization transform is the Tustin transform (also referred to as the “Bilinear Z” transform) Other substitutions can be possible.

At step 540, the arc voltage estimation module 250 calculates the estimate of the arc voltage V_{ARC} based on the difference between the voltage applied to the input of the inductor L1 from step 520 and the calculated voltage drop across the inductor from step 530. For example, after substitution of Equation (3) into Equation (2), the arc voltage estimate V_{ARC} can be obtained from the following:

$${V}_{Arc} = D * {V}_{IN} - L \frac{d i}{d t} = D * {V}_{IN} - L * {I}_{s} * ( 1 - {z}^{- 1} ) \qquad ( 4 )$$

Equation (4) provides an accurate estimate of arc voltage but in practice is sensitive to noise in the current measurement Iₛ and requires low pass filtering that significantly affects the estimate. Also Equation (4) implicitly assumes that the output voltage changes so slowly as to be essentially constant throughout the PWM switching period and makes a sudden step change at the sampling instant. In the case of plasma arc loads, this assumption generally does not hold. Rather, the voltage across a plasma arc can be highly dynamic with rapid changes relative to typical PWM switching periods.

According to a third embodiment, the accuracy of the arc voltage estimate can be further improved by starting with the assumption the arc voltage V_{ARC} changes throughout the PWM switching period. Many different profiles can be assumed for the change in arc voltage V_{ARC}, including linear, parabolic, exponential profiles, for example.

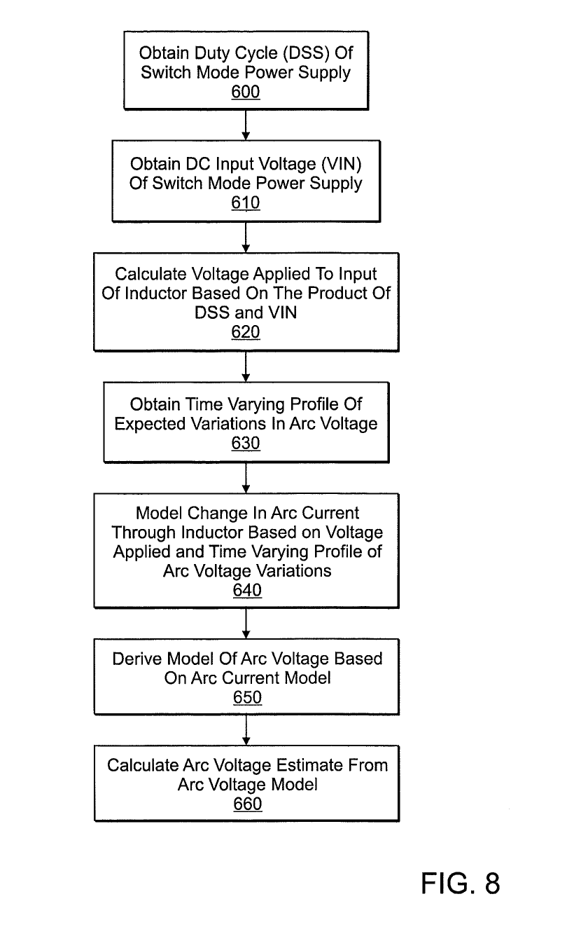

FIG. 8 is a flow diagram illustrating a method of arc voltage estimation according to the third embodiment. Steps 600, 610 and 620 are similar to steps 400, 410 and 420, respectively, as previously described in FIG. 6. At step 630, the arc voltage estimation module 250 obtains a time varying profile representing expected variation in the arc voltage. Such variations may be modeled as linear, parabolic, exponential, or using any other mathematical or statistical representation.

At step 640, the arc voltage estimation module 250 models the change in arc current through the inductor based on the voltage applied to the input of the inductor and the time varying profile of the expected variations in arc voltage. At step 650, the arc voltage estimation module 250 derives a model of the arc voltage based on the model of the change in arc current through the inductor. At step 660, the arc voltage estimation module 250 calculates the arc voltage estimate from the model derived in step 650.

Although not so limited, the following is an example of a method for estimating the arc voltage according to the third embodiment. For the purpose of example only, the arc voltage is assumed herein to vary linearly throughout the PWM switching period. However, as previously discussed, the variation in arc voltage over time can be modeled as linear, parabolic, exponential, or using any other mathematical or statistical representation.

The following table includes a description of terms discussed in following example for estimating the arc voltage according to the third embodiment.

TABLE 1

| | |
|---|---|
| Iₛₐₘₚₗₑ or Iₛ or Is * z⁰ | present current sample |
| z⁻¹ | time delay operator that denotes a time |
| | delay of ‘T’ seconds |
| Is * z⁻¹ | current sample preceding present current |
| | sample |
| D | duty cycle of the current switching period |
| L | inductance in henries. |
| T | switching period in seconds. |
| V_{arc} | arc voltage estimate |
| V_{IN} | input dc voltage |
| V_{applied} | Average voltage applied to the input of the |
| | inductor and load |

A single switching period begins with a current sample and ends with a current sample. The average voltage applied to the output circuit (i.e., the inductor and the load) is:

V_{applied}=D*V_{IN} (1)

The basic equation for the voltage across an inductor is:

$$v = L \frac{d i}{d t} \qquad ( 2 )$$

Converting to a discrete form we obtain:

$${V}_{L} = L * ( \frac{{I}_{s} - {I}_{s} * {z}^{- 1}}{T} ) = {I}_{s} * ( 1 - {z}^{- 1} ) * ( \frac{L}{T} ) \qquad ( 3 )$$

The change in the Arc Voltage between sampling instants is:

ΔV_{arc}=V_{arc}−V_{arc}*z⁻¹=V_{arc}*(1−z⁻¹) (4)

The rate of change of the Arc Voltage is:

$${V}_{rate} = \frac{Δ {V}_{arc}}{T} \qquad ( 5 )$$

The change in the Arc Current between sampling instants is:

ΔIₛ=Iₛ−Iₛ*z⁻¹=Iₛ*(1−z⁻¹) (6)

Assuming a linear uniformly changing Arc Voltage:

$$Δ {I}_{s} = {\int }_{0}^{D * T} \frac{{V}_{IN} - ( {V}_{arc} + {V}_{rate} * t )}{L} d t + {\int }_{D * T}^{T} \frac{0 - ( {V}_{arc} + {V}_{rate} * t )}{L} d t \qquad ( 7 )$$

Simplifying:

$$Δ {I}_{s} = ( D * {V}_{IN} - {V}_{arc} - \frac{{V}_{rate} * T}{2} ) * ( \frac{T}{L} ) \qquad ( 8 )$$

$${V}_{rate} = \frac{Δ {V}_{arc}}{T} \text{:}$$

Back substituting

$$Δ {I}_{s} = ( D * {V}_{IN} - {V}_{arc} - \frac{Δ {V}_{arc}}{2} ) * ( \frac{T}{L} ) \qquad ( 10 )$$

Back substitutingΔV_{arc}=V_{arc}*(1−z⁻¹) (11)

$$Δ {I}_{s} = ( D * {V}_{IN} - {V}_{arc} - \frac{{V}_{arc} * ( 1 - {z}^{- 1} )}{2} ) * ( \frac{T}{L} ) \qquad ( 12 )$$

Solving for V_{ARC}:

$${V}_{arc} = ( \frac{2}{3} ) * ( \frac{D * {V}_{IN} - {I}_{s} * ( 1 - {z}^{- 1} ) * ( \frac{L}{T} )}{1 - ( \frac{1}{3} ) * {z}^{- 1}} ) \qquad ( 13 )$$

Solving for a recursive, implementable form:

$${V}_{arc} = ( \frac{1}{3} ) * {V}_{arc} * {z}^{- 1} + [ ( \frac{2}{3} ) * ( D * {V}_{IN} - {I}_{s} * ( 1 - {z}^{- 1} ) * ( \frac{L}{T} ) ) ] \qquad ( 14 )$$

This technique is extendable to other models of arc voltage behavior including, for example, parabolic models in which the arc voltage varies with t².

With respect to all of the embodiments, one or more of the steps described can be combined as known to those skilled in the art.

While this invention has been particularly shown and described with references to preferred embodiments thereof, it will be understood by those skilled in the art that various changes in form and details may be made therein without departing from the scope of the invention encompassed by the appended claims.

What is claimed:

1. A method of controlling a process parameter of a thermal processing system in which a switch mode power supply provides an arc current to generate a plasma arc between a plasma arc torch tip and a metallic workpiece, the method comprising:
estimating an arc voltage between the plasma arc torch tip and the metallic workpiece; and
controlling a process parameter of the thermal processing system based on the estimated arc voltage.

2. The method of claim 1 wherein controlling the process parameter comprises:
adjusting the height of a plasma arc torch based on the estimated arc voltage.

3. The method of claim 1 wherein the switch mode power supply includes an output inductor, the method further comprising:
estimating the arc voltage based on an average voltage applied to the input of the inductor.

4. The method of claim 1 wherein the switch mode power supply includes an output inductor, the method further comprising:
estimating the arc voltage based on the difference between an average voltage applied to the input of the inductor and a voltage drop across the inductor.

5. The method of claim 1 wherein the switch mode power supply includes an output inductor, the method further comprising:
obtaining a time varying profile of expected variations in arc voltage; and
estimating the arc voltage from a model representing changes in arc current through the inductor, the model based on an average voltage applied to an input of the inductor and the time varying profile of expected variations in the arc voltage.

6. A method for estimating an arc voltage in a thermal processing system in which a switch mode power supply provides an arc current to generate a plasma arc between a plasma arc torch tip and a metallic workpiece, the method comprising:
obtaining a duty cycle of the switch mode power supply;
obtaining a value representing a dc input voltage of the switch mode power supply; and
estimating the arc voltage between the plasma arc torch tip and the metallic workpiece based on a combination of the duty cycle of the switch mode power supply and the value representing the dc input voltage of the switch mode power supply.

7. The method of claim 6 further comprising:
calculating the duty cycle of the switch mode power supply based on a ratio of a sampled error signal to a peak value of a carrier wave signal, the sampled error signal comparing a measured value of the arc current to a preset current reference.

8. The method of claim 6 further comprising:
measuring the value representing the dc input voltage of the switch mode power supply.

9. The method of claim 6 further comprising:
deriving the value representing the dc input voltage of the switch mode power supply from an ac input voltage.

10. The method of claim 6 further comprising:
scaling a value representing an input voltage of the switch mode power supply.

11. A method for estimating an arc voltage in a thermal processing system in which a switch mode power supply including an output inductor provides an arc current to generate a plasma arc between a plasma arc torch tip and a metallic workpiece, the method comprising:
obtaining an average voltage applied to an input of the inductor;
obtaining a value corresponding to a voltage drop across the inductor; and
estimating the arc voltage based on the difference between the average voltage applied and the voltage drop.

12. The method of claim 11 further comprising:
obtaining a duty cycle of the switch mode power supply;
obtaining a value representing a dc input voltage of the switch mode power supply; and
obtaining the average voltage applied to the input of the inductor based on the product of the duty cycle of the switch mode power supply and the value representing the dc input voltage of the switch mode power supply.

13. The method of claim 11 further comprising:
obtaining the voltage drop across the inductor based on time varying changes in current through the inductor.

14. A method for estimating an arc voltage in a thermal processing system in which a switch mode power supply including an output inductor provides an arc current to generate a plasma arc between a plasma arc torch tip and a metallic workpiece, the method comprising:
obtaining a time varying profile of expected variations in arc voltage;
obtaining an average voltage applied to an input of the inductor; and
estimating the arc voltage from a model representing changes in arc current through the inductor, the model based on an average voltage applied to the input of the inductor and the time varying profile of expected variations in the arc voltage.

15. The method of claim 14 wherein the time varying profile is a mathematical or statistical representation of expected variations in arc voltage;

16. A system for controlling a process parameter of a thermal processing system, the system comprising:
a switch mode power supply that provides an arc current to generate a plasma arc between a plasma arc torch tip and a metallic workpiece;
an arc voltage estimation module that estimates an arc voltage between the plasma arc torch tip and the metallic workpiece; and
a process controller that controls a process parameter of the thermal processing system based on the estimated arc voltage.

17. The system of claim 16 wherein the process controller is a torch height controller that adjusts the height of a plasma arc torch based on the estimated arc voltage.

18. The system of claim 16 wherein the switch mode power supply includes an output inductor and the arc voltage estimation module estimates the arc voltage based on an average voltage applied to the input of the inductor.

19. The system of claim 16 wherein the arc voltage estimation module estimates the arc voltage based on the difference between an average voltage applied to the input of the inductor and a voltage drop across the inductor.

20. The system of claim 16 wherein the switch mode power supply includes an output inductor and the arc voltage estimation module estimates the arc voltage from a model representing changes in current through the inductor, the model based on an average voltage applied to an input of the inductor and a time varying profile of expected variations in the arc voltage.

21. An apparatus that estimates an arc voltage in a thermal processing system in which a switch mode power supply provides an arc current to generate a plasma arc between a plasma arc torch tip and a metallic workpiece, the apparatus comprising:
processing means for obtaining a duty cycle of the switch mode power supply;
processing means for obtaining a value representing a dc input voltage of the switch mode power supply; and
processing means for estimating the arc voltage between a plasma arc torch tip and the metallic workpiece based on a combination of the duty cycle of the switch mode power supply and the value representing the dc input voltage of the switch mode power supply.

22. An apparatus that estimates an arc voltage in a thermal processing system in which a switch mode power supply including an output inductor provides an arc current to generate a plasma arc between a plasma arc torch tip and a metallic workpiece, the apparatus comprising:
processing means for obtaining an average voltage applied to an input of the inductor;
processing means for obtaining a value corresponding to a voltage drop across the inductor; and
processing means for estimating the arc voltage based on the difference between the average voltage applied and the voltage drop.

23. An apparatus that estimating an arc voltage in a thermal processing system in which a switch mode power supply including an output inductor provides an arc current to generate a plasma arc between a plasma arc torch tip and a metallic workpiece, the method comprising:
processing means for obtaining a time varying profile of expected variations in arc voltage;
processing means for obtaining an average voltage applied to an input of the inductor; and
processing means for estimating the arc voltage from a model representing changes in arc current through the inductor, the model based on an average voltage applied to the input of the inductor and the time varying profile of expected variations in the arc voltage.

24. The method of claim 1 wherein the switch mode power supply is based on a boost, buck or buck-boost circuit topology.

25. The method of claim 6 wherein the switch mode power supply is based on a boost, buck or buck-boost circuit topology.

26. The method of claim 11 wherein the switch mode power supply is based on a boost, buck or buck-boost circuit topology.

27. The method of claim 14 wherein the switch mode power supply is based on a boost, buck or buck-boost circuit topology.

28. The method of claim 6 wherein the combination is one of a summation or product.

29. The method of claim 21 wherein the combination is one of a summation or product.
